(19) United States
(12) Patent Application Publication
(10) Pub. No.: US 2016/0076538 A1
(43) Pub. Date: Mar. 17, 2016

(54) Piston Pump, in Particular High-Pressure Fuel Pump

(71) Applicant: ROBERT BOSCH GMBH, Stuttgart (DE)

(72) Inventors: Siamend Flo, Schwieberdingen (DE); Andreas Plisch, Marbach (DE); Michael Lenz, Korntal-Muenchingen (DE); Tamim Latif, Stuttgart (DE); Stefan Woerner, Besigheim-Ottmarsheim (DE)

(73) Assignee: Robert Bosch GmbH, Stuttgart (DE)

(21) Appl. No.: 14/783,463

(22) PCT Filed: Mar. 26, 2014
(86) PCT No.: PCT/EP2014/056048

§ 371 Date: Oct. 9, 2015

(30) Foreign Application Priority Data
Apr. 17, 2013 (DE) 10 2013 206 930.8

(51) Int. Cl. F04B 53/16; F02M 59/02; F04B 53/22; F04B 19/22; F04B 53/10

(52) U.S. Cl. CPC F04B 53/166; F04B 19/22; F04B 53/10; F04B 53/22; F02M 59/025

(57) ABSTRACT

A piston pump, in particular high-pressure fuel pump, has a cylinder liner and at least one coupling element. The at least one coupling element is fastened to the cylinder liner for the retention of a valve device. The at least one coupling element is a tubular sleeve.

### STATE OF THE ART

The invention relates to a piston pump according to the preamble of claim 1.

Fuel systems for internal combustion engines, which comprise, among other things, a high-pressure fuel pump, which serves for delivering a particular quantity of fuel required into a fuel accumulator or fuel distributor at a particular, desired pressure, are known from the market. Such high-pressure fuel pumps are designed, for example, as piston pumps. In these pumps a piston seated radially on a cam or balancer shaft converts a rotary motion into a reciprocating motion. The fuel in a working chamber of the high-pressure fuel pump can be compressed by the stroke of the piston and delivered to a high-pressure side of the high-pressure fuel pump or the fuel system. Major elements of such high-pressure fuel pumps are often produced in one piece using machining and/or forging processes requiring a correspondingly large amount of material.

### DISCLOSURE OF THE INVENTION

The problem addressed by the invention is solved by a piston pump as claimed in claim 1. Advantageous developments are specified in dependent claims. Features important for the invention are also contained in the following description and in the drawings, the features possibly being important for the invention both in isolation and in various combinations, without further attention being drawn explicitly to this.

The invention has the advantage that a weight of a high-pressure fuel pump can be reduced and manufacturing costs lowered. The piston pump according to the invention allows better hydraulic interconnection of elements inside the piston pump.

This can also result in lower suction losses of the piston pump and better filling of a working chamber of the piston pump. Any vaporization inside the piston pump can thereby be prevented, reducing the risk of piston seizing. A supply pressure of the piston pump according to the invention can possibly be reduced. The piston pump moreover encloses a relatively large fuel volume, making it possible to damp hydraulic pulsations in the low-pressure range of the piston pump. A substantially uniform heating of a piston and a cylinder liner of the piston pump moreover ensues during operation. A reduced tendency to piston seizing is thereby likewise achieved. The piston pump according to the invention can furthermore be produced with fewer machining production operations. Elements of the piston pump can often be designed as turned parts or a deep-drawn sheet-metal part that are relatively easy to produce.

The invention relates to a piston pump, in particular a high-pressure fuel pump, having a cylinder liner and at least one coupling element fixed to the cylinder liner for coupling a functional device, in particular a valve device, to the cylinder liner, particularly for coupling in a direction at right angles to the longitudinal axis of the cylinder liner. According to the invention at least the one coupling element is a tubular sleeve. According to the invention the term “tubular sleeve” allows scope for the coupling element also to comprise portions of various designs in an axial direction. For example, the coupling element may be of substantially cylindrical design over a first axial area and of substantially tapering design or the like over a second axial area. Besides a considerable reduction in weight, the fact that the coupling element is designed not as a solid construction but as a tubular sleeve at the same times means that a fuel volume present in the piston pump (outside the cylinder liner and coupling element) can be enlarged, thereby affording the advantages described above. This means that the piston pump can be of particularly simple and at the same time robust construction, considerably reducing the amount of raw material required. The cylinder liner of the piston pump according to the invention is preferably also designed as a substantially tubular sleeve, so that a plurality of the interconnected elements of the piston pump are of a common “sleeve design”. For example, two coupling elements are connected to the cylinder liner. The piston pump can advantageously be used as a high-pressure fuel pump in a fuel system for an internal combustion engine, for example in a motor vehicle.

In particular, the cylinder liner may be welded to the coupling element. For example, the weld seams may be produced by capacitor-discharge welding, resulting in a durable and especially cost-effective connection. Alternative joining techniques are laser welding or soldering. Pressing is also feasible.

The valve device may furthermore comprise a quantity control valve and/or a discharge valve. Here the quantity control valve and the discharge valve are each arranged on or in a separate coupling element designed as a tubular sleeve. Integrating the quantity control valve or the discharge valve or both of these gives the piston pump according to the invention an especially compact build construction. The weight of the piston pump and the overall costs of the fuel system can thereby be reduced.

In one development of the invention the piston pump comprises a cup-shaped housing with a casing portion having a fluid-tight connection to at least the one coupling element. For example, the connection can likewise be made by weld seams, in particular by means of a capacitor-discharge welding method. The cup-shaped housing of the piston pump according to the invention may be manufactured as a deep-drawn part, resulting in a relatively low weight and low manufacturing costs. The cup-shaped housing is nevertheless sufficiently robust for the relatively rough operation of a high-pressure fuel pump. The casing portion of the housing is connected to a respective axial end portion of the coupling element, for example.

In addition, the cup-shaped housing may define a cavity, which is hydraulically connected to an inlet port of the piston pump. The cup-shaped housing of the piston pump means that the cavity can enclose a comparatively large volume. Connecting the cavity to the inlet port advantageously allows the cavity to contribute to a hydraulic pulsation damping of the piston pump in the low-pressure range.

In a further development of the invention the piston pump comprises a possibly multipart flange portion, which externally closes the cup-shaped housing and serves as support for a piston spring and as holder for a piston seal. The flange portion is preferably arranged on an end portion of the cup-shaped housing of the piston pump, which faces a mounting structure of the internal combustion engine carrying the piston pump. The flange portion therefore not only serves for fluid-tight closure of the cup-shaped housing, but at the same time can also be used as support for the piston spring and as holder for the piston seal. This makes the piston pump particularly easy and cost effective to manufacture.

According to the invention the cup-shaped housing and/or the flange portion can furthermore be manufactured using drawn and/or stamped and/or bent sheet metal plates or as injection-molded parts. These design possibilities make the cup-shaped housing and the flange portion particularly easy and moreover cost effective to produce in lightweight form.

In yet another development of the invention an axial end portion of the cylinder liner is designed as an inlet connection. The inlet connection is preferably formed in the direction of a longitudinal axis of the cylinder liner. The inlet connection can thereby be connected directly to an axial end portion (“end face”) of the cup-shaped housing, for example by welding. The form of the inlet connection can result in cost advantages and in a reduction in the number of parts of the piston pump. In addition, functional advantages also accrue, since it is possible to increase the stability of the piston pump according to the invention. In particular, it is possible to reduce significantly a load stress acting on the weld seams between the casing portions of the cup-shaped housing and the coupling elements, thereby also improving the fatigue strength of the piston pump. In addition it is possible to reduce oscillations, particularly at the end face of the cup-shaped housing and therefore to improve the acoustic.

In addition, the inlet connection can be connected to the cavity by at least one radial bore. This is a simple but at the same time effective way of advantageously using the cavity formed by the cup-shaped housing for hydraulic pressure damping, thereby making it possible to reduce pressure pulsations in the operation of the piston pump.

Exemplary embodiments of the invention are explained below with reference to the drawing. In the drawing:

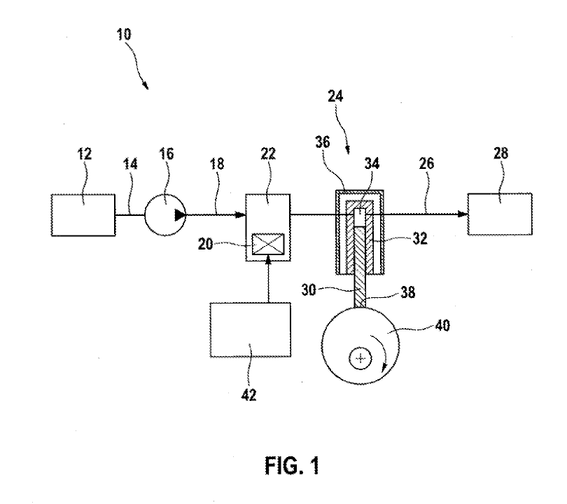

FIG. 1 shows a simplified diagram of a fuel feed device for an internal combustion engine;

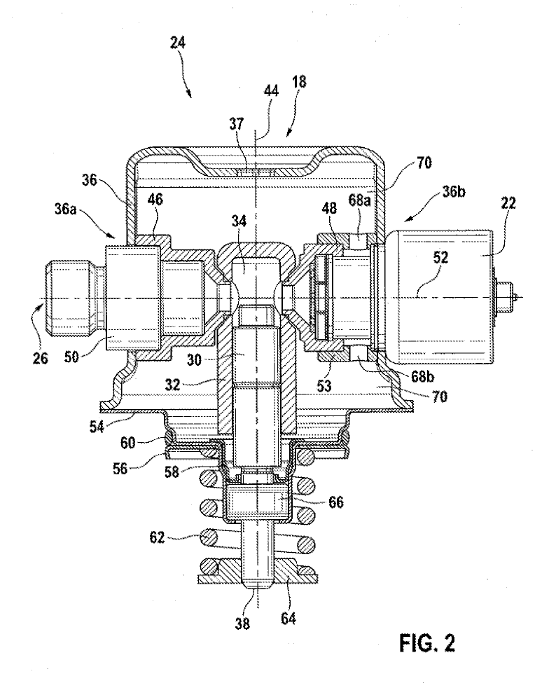

FIG. 2 shows a sectional representation of a first embodiment of a piston pump of the fuel feed device;

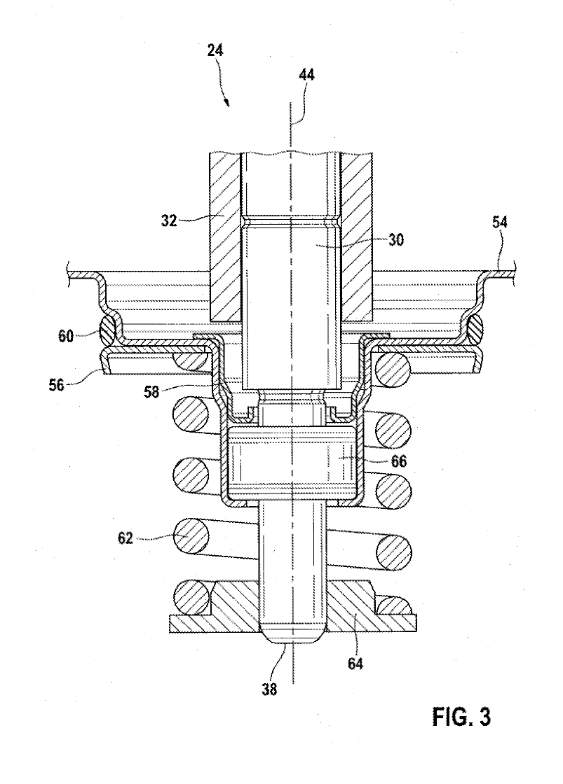

FIG. 3 shows an enlarged representation of a lower area of the drawing in FIG. 2;

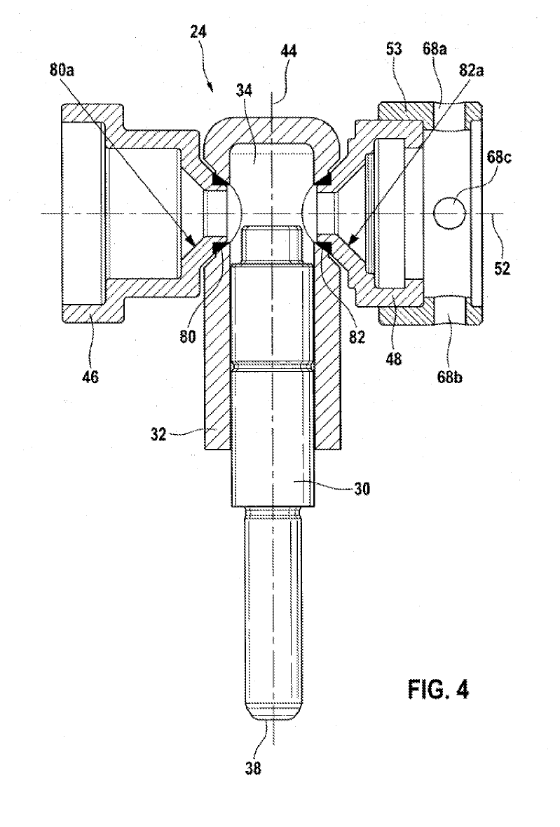

FIG. 4 shows an enlarged representation of elements of a middle area of the drawing in FIG. 2; and

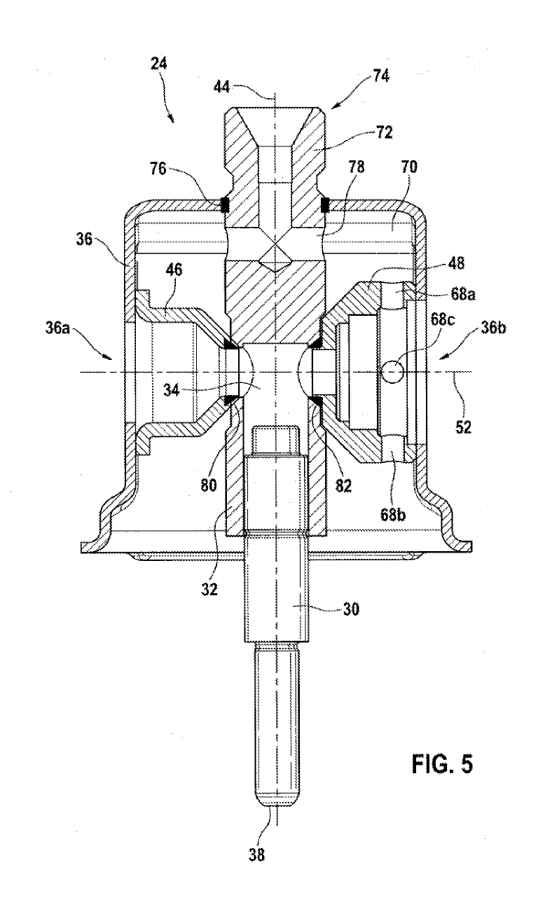

FIG. 5 shows a sectional representation of a second embodiment of a piston pump of the fuel feed device.

The same reference numerals are used for functionally equivalent elements and dimensions in all figures, even in different embodiments.

FIG. 1 shows a greatly simplified representation of a fuel feed device 10 for an internal combustion engine, not represented further. From a fuel tank 12 fuel is fed via a suction line 14, by means of a pre-supply pump 16, via a low-pressure line 18, and via a quantity control valve 22, actuated by a solenoid actuating device 20 (“solenoid”), to a high-pressure fuel pump—hereinafter referred to as a piston pump 24. Downstream, the piston pump 24 is connected to a high-pressure reservoir 28 (“common rail”) by way of a high-pressure line 26.

FIG. 1 furthermore diagrammatically shows a housing 36 of the piston pump 24, a cylinder liner 32, a piston arranged in the cylinder liner 32 and a working chamber 34 enclosed by the cylinder liner 32, together with a disk cam 40 acting on an axial end portion 38 of the piston 30. Other elements, such as valves of the piston pump 24, for example, are not shown in FIG. 1. The solenoid actuating device 20 is controlled by a control device 42.

It goes without saying that the quantity control valve 22 may also be formed as a standard component together with the piston pump 24, as is further shown in the succeeding FIGS. 2 to 5. For example, the quantity control valve 22 may be a forcibly opened inlet valve of the piston pump 24.

When the fuel feed device 10 is in operation, the pre-supply pump 16 delivers fuel from the fuel tank 12 into the low-pressure line 18. Here the quantity control valve 22 controls the quantity of fuel delivered to the working chamber 34. The quantity control valve 22 can be closed and opened as a function of a particular fuel demand. The fuel is petrol or diesel fuel, for example.

FIG. 2 shows a sectional representation of a first embodiment of the piston pump 24 of the fuel feed device 10 according to FIG. 1. The piston pump 24 comprises the housing 36 of cup-shaped design, which encloses further elements of the piston pump 24. In this case the cup-shaped housing 36 is manufactured as a drawn, stamped and bent sheet-metal part, which among other things combines the functions of a “cover” and a fixing flange of conventional high-pressure fuel pumps. Alternatively, the cup-shaped housing 36 may be manufactured as an injection-molded part. The piston pump 24 is substantially of a design rotationally symmetrical about a vertical longitudinal axis 44 in the drawing.

The cylinder liner 32 is arranged in a middle area of the piston pump 24 in FIG. 2, coaxially with the longitudinal axis 44 of the piston pump 24. The piston 30 is moveable vertically in the cylinder liner 32. A first coupling element 46 and a second coupling element 48 are arranged at radial ports (no reference numerals) of the cylinder liner 32 on the left-hand and right-hand side of the drawing respectively.

The radial ports, the first coupling element 46 and the second coupling element 48 are made substantially rotationally symmetrical in relation to a transverse axis 52 arranged at right-angles to the longitudinal axis 44 and have substantially the geometry of tubular sleeves. In particular, the coupling elements 46 and 48 each comprise a radially inner cavity and on an end portion in each case facing the cylinder liner 32 have a substantially tapering geometry. Radially outside on the tapering end portion, the first coupling element 46 and the second coupling element are each welded fluid-tightly to a circumferential edge portion of the ports of the cylinder liner 32, which will be explained in more detail in FIG. 4. In this case the cylinder liner 32 and the coupling elements 46 and 48 connected thereto are collectively also referred to as a “sleeve construction”.

A first valve device, in this case a discharge valve 50, of the piston pump 24 is arranged as functional element on and in some areas in the first coupling element 46. A second valve device, in this case the quantity control valve 22, is arranged as functional element on and in some areas in the second coupling element 48. The discharge valve 50 and the quantity control valve 22 likewise have a substantially rotationally symmetrical geometry in relation to the transverse axis 52 and are pressed into the coupling elements 46 and 48 and/or welded thereto. A central inlet port 37 for connection to the low-pressure line 18 is present in the base of the cup-shaped housing 36.

In an axially approximately middle area the cup-shaped housing 36 comprises a casing portion 36a on the left-hand side of the drawing, which has a fluid-tight, for example welded, connection to the first coupling element 46. The second coupling element 48, however, has a fluid-tight, for example welded, connection to a comparable right-hand casing portion 36b of the cup-shaped housing 36 by means of an intermediate element 53. The intermediate element 53 has a radially inner cavity and two radial ports 68a and 68b connected thereto.

The intermediate element 53 is likewise substantially of rotationally symmetrical design in relation to the transverse axis 52 and is connected, for example pressed or welded, to a radially outer end portion of the second coupling element 48 on the right-hand side of the drawing. In this respect it might also be said that the intermediate element may form a coupling element seen as belonging to the coupling element 48 and possibly even integrally formed with the latter. An end portion of the quantity control valve 22, on the left-hand side in the drawing, protrudes through the cavity of the intermediate element 53 and is at the same time connected to a radially inner wall face of the second coupling element 48.

A multipart flange portion is arranged on a lower end portion of the cup-shaped housing 36 in the drawing in FIG. 2. The multipart flange portion comprises a first flange portion in the form of a seal carrier 54, a second flange portion designed as seal holder 56 and an inner flange portion 58. The seal carrier 54, the seal holder 56 and the inner flange portion 58 are each likewise substantially of rotationally symmetrical design in relation to the longitudinal axis 44. The multipart flange portion corresponds, among other things, to a “customer connection” of a conventional high-pressure fuel pump, enabling the later to be accommodated in a “mounting structure”, for example a cylinder head of an internal combustion engine.

In this case the elements of the multipart flange portion are produced using drawn or stamped, bent sheet-metal plates (“deep-drawn parts”). Since the multipart flange portion defines a low-pressure area of the piston pump 24, its elements are of relatively thin and lightweight design. Alternatively, these elements may be produced as injection-molded parts.

Three said elements are in contact with one another at least by pairs, or they are connected to one another non-positively or by cohesive material joints at least in some areas and by pairs. In particular, the seal holder 56, in a radially inner area, is designed as a washer, portions of the seal carrier 54 and of the inner flange portion 58 protruding through a hole arranged centrally in the seal holder 56.

A housing seal 60, which here is designed as an O-ring, is arranged in a circumferential, radially inward depression of the seal carrier 54. Here the seal holder 56 together with the circumferential depression in the seal carrier 54 forms a radially circumferential groove, in which the housing seal 60 is held by positive interlock. The seal carrier 54 has a fluid-tight, in this case likewise welded, connection to a lower end portion of the cup-shaped housing 36 in FIG. 2.

In a lower area of the drawing a piston spring 62 embodied as a helical spring is arranged concentrically with the longitudinal axis 44. The piston spring 62 is arranged partially on a radially outer portion of the seal carrier 54. Here an upper end portion of the piston spring 62 in the drawing bears on the radially extending flange-like portion of the seal holder 56, which therefore also forms a support for the piston spring 62. A lower end portion of the piston spring 62 in the drawing bears on a spring seat 64, which is connected non-positively or by cohesive material joint to a lower end portion of the piston 30 in the drawing.

The piston 30 formed in one piece has substantially three diameters (no reference numerals). In a middle area of the piston 30 the piston 30 has a relatively large diameter, which substantially corresponds to an inside diameter of the cylinder liner 32. In an upper and a lower end portion of the piston 30 the latter in each case has a reduced diameter. The lower end portion of the piston 30 is radially enclosed by a piston seal 66 held by the seal carrier 54, so that a leakage of fuel from the piston pump 54 into the mounting structure (not shown) or conversely a leakage of liquid media (for example engine oil) from the mounting structure into the piston pump 24 can be prevented or at least minimized.

In the operation of the piston pump 24, in a manner comparable to FIG. 1, fuel is delivered from the low-pressure line 18 via the central port 37 in the base of the cup-shaped housing 36 and the ports 68a and 68b to the quantity control valve 22, and thence into the working chamber 34 and finally to the discharge valve 50 and into the high-pressure line 26.

Here the fuel flows through the central port 37 into what is, in the drawing, an upper cavity 70 in the cup-shaped housing 36. In the drawing the cup-shaped housing 36 defines the cavity 70 radially and at the top, the seal carrier 54 and the seal holder 56 define it at the bottom. Overall the cavity 70 comprises an area (“damper chamber”) arranged above the coupling elements 46 and 48 in the drawing and an area (“stepped chamber”) arranged below the coupling elements 46 and 48 in the drawing. A hydraulic damper present in the damper chamber is not represented in FIG. 2 and in FIGS. 3 to 5 described below.

The embodiment of the piston pump 24 represented in FIG. 2, having relatively thin-walled elements (particularly the cup-shaped housing 36, the cylinder liner 32, the intermediate element 53 and the coupling elements 46 and 48), means that the cavity 70 can receive a relatively large volume of fuel. A hydraulic interconnection of the various functional areas of the piston pump can thereby be improved, and hydraulic pressure pulsations in the operation of piston pump 24 can be more effectively damped.

Furthermore in the operation of the piston pump 24 the arrangement represented in the figures allows a substantially even and rapid temperature control, especially of the relatively detached cylinder liner 32. A rapid dissipation of heat via the relatively thin-walled and lightweight housing 36 can thereby be prevented. A risk of the piston 30 seizing in the cylinder liner 32 can therefore be reduced considerably.

FIG. 3 shows an enlarged representation of what is, in the drawing, a lower area of the piston pump in FIG. 2. In particular, the arrangement of a multipart flange portion, in this case comprising the seal carrier 54, the seal holder 56 and the inner flange portion 58, can be better seen.

FIG. 4 shows an enlarged representation of elements of the piston pump 24 of what is, in the drawing, a middle area of FIG. 2. For greater clarity, however, some of these elements are not shown in FIG. 4. A third radial port 68c can be seen on the intermediate element 53. Overall the intermediate element 53 and the second coupling element 48 (cf. FIG. 5 below) can also be designed with more than three or four radial ports 68a to 68c.

The coupling elements 46 and 48 are welded to the associated ports of the cylinder liner 32 by radially circumferential weld seams 80 and 82 arranged on end portions of the coupling elements 46 and 48. In this case the weld seams 80 and 82 are produced by capacitor discharge welding. In FIG. 2 an apparent penetration of the end portions of the coupling elements 46 and 48 by the edge areas of the ports of the cylinder liner 32 can be seen. Suitable alternative joining techniques are laser welding or soldering.

Also identified by arrows in FIG. 4 are contact points 80a and 80b for switching on welding electrodes (not represented). In the present arrangement of the weld seams 80 and 82 and the associated contact points 80a and 80b, the coupling elements 46 and 48 can even be welded to the cylinder liner 32 in a single operation by capacitor discharge welding. In the case of a possibly less suitable arrangement of said elements, the welding is performed in two operations, in which the coupling elements 46 and 48 are welded to the cylinder liner 32 individually in succession.

FIG. 5 shows a sectional representation of a second embodiment of the piston pump 24 of the fuel feed device 10. Unlike FIG. 2, in FIG. 5 some elements of the piston pump 24 are not represented.

In this case an axial end portion 72 of the cylinder liner 32 is embodied as an inlet connection 74. A radially outer area of the axial end portion 72 has a fluid-tight connection, by means of a radially circumferential weld seam 76, to the base of the cup-shaped housing 36 situated at the top in the drawing. Inside the cup-shaped housing 36 the axial end portion 72 of the cylinder liner 32 further comprises a radial through-bore 78 made transversely to the longitudinal axis 44, by means of which a fluid duct of the inlet connection 74 is hydraulically connected to the cavity 70. The first coupling element 46 and the second coupling element 48 each have a fluid-tight connection by means of a radially circumferential weld seam 80 and 82 to the radial ports of the cylinder liner 32, which are made around the transverse axis 52. Alternatively, the weld seams 76, 80 and 82 may also made as soldered seams.

Overall the embodiment of the piston pump 24 according to FIG. 5 has an especially high mechanical stability. This results, in particular, from the fact that the cylinder liner 32 is firmly connected by the axial end portion 72 to the cup-shaped housing 36 by means of the weld seam 76. As a result in the operation of the piston pump 24 the load stress on the weld seams 80 and 82 can be relatively low. In addition, the rigid connection of the cylinder liner, 32 by its axial end portion 72, to the cup-shaped housing 36 stabilizes the base of the cup-shaped housing 36, thereby reducing any oscillations of the cup-shaped housing 36 and consequently reducing the noise of the piston pump 24. In a manner comparable to FIG. 2, the cavity 70, the radial through-bore 78 and the radial ports 68a, 68b and 68c endow the piston pump 24 in FIG. 5 with relatively good hydraulic pressure damping in the low-pressure range.

1. A piston pump comprising:
a cylinder liner; and
at least one coupling element fixed to the cylinder liner and configured to couple a functional device to the cylinder liner,
wherein the at least one coupling element is a tubular sleeve.

2. The piston pump as claimed in claim 1, wherein the cylinder liner is welded to the at least one coupling element.

3. The piston pump as claimed in claim 1, wherein the valve functional device comprises includes one of a quantity control valve and a discharge valve.

4. The piston pump as claimed in claim 1, further comprising a cup-shaped housing with a casing portion having a fluid-tight connection to at least the one coupling element.

5. The piston pump as claimed in claim 4, wherein:
the cup-shaped housing defines a cavity, and
the cavity is hydraulically connected to an inlet port of the piston pump.

6. The piston pump as claimed in claim 4, further comprising a possibly multipart flange portion configured to close the cup-shaped housing, support a piston spring, and hold a piston seal.

7. The piston pump as claimed in claim 6, wherein at least one of the cup-shaped housing and the flange portion is manufactured using at least one of drawn, stamped, and bent sheet metal plates or as injection-molded parts.

8. The piston pump as claimed in claim 5, wherein an axial end portion of the cylinder liner is an inlet connection.

9. The piston pump as claimed in claim 8, wherein the inlet connection is connected to the cavity by at least one radial bore.

10. The piston pump as claimed in claim 1, wherein the piston pump is a high-pressure fuel pump.

11. The piston pump as claimed in claim 1, wherein the functional device is a valve device.
